(19) United States
(12) Patent Application Publication
(10) Pub. No.: US 2007/0284483 A1
(43) Pub. Date: Dec. 13, 2007

(54) MOBILE AIRFOIL DEVICE FOR AN AIRCRAFT WING

(75) Inventor: Jerome Milliere, Leguevin (FR)

Correspondence Address: PERMAN & GREEN, 425 POST ROAD, FAIRFIELD, CT, 06824, US

(73) Assignee: AIRBUS FRANCE, Toulouse (FR)

(21) Appl. No.: 11/760,934

(22) Filed: Jun. 11, 2007

(30) Foreign Application Priority Data
Jun. 13, 2006 (FR) 06 52113

(51) Int. Cl. B64C 9/32

(52) U.S. Cl. 244/217

(57) ABSTRACT

The invention concerns a mobile airfoil device that can locally modify the lift of an aircraft wing, including an upper panel and a lower panel and at least one actuator per panel in order to move the panels independently of one another between a first position, called rest, in which the outer surface of each of the panels forms a continuous surface with the upper surface and the lower surface of the wing, respectively, and a second position in which one of the two panels is deployed to form an angle with the corresponding surface of the wing, the actuators being positioned between the upper and lower panels in a recess of the wing.

The disclosed embodiments concerns a mobile airfoil device for an aircraft wing, and more particularly of airfoils whose deflection movement locally modifies the lift of the aircraft wing.

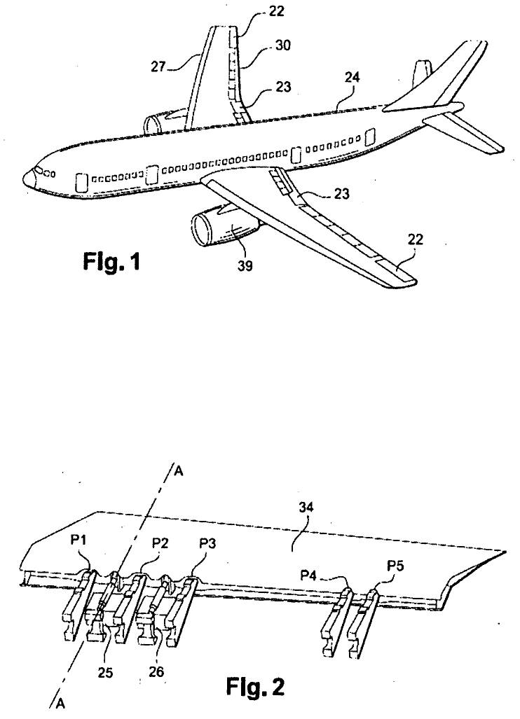

One example of an aircraft wing is illustrated in FIG. 1. It is defined by an upper surface and a lower surface called, respectively, upper surface and lower surface, a leading edge 27 and a trailing edge 30. Generally, it is endowed at its leading edge 27 with an assembly of fixed or mobile aerodynamic devices used to improve flow at large angles and to increase the lift of the wing, and at its trailing edge 30, with an assembly of high-lift devices and an assembly of mobile elements to locally modify the lift of the wing. The device of the disclosed embodiments is applied more particularly to the assembly of mobile elements more generally called ailerons.

The wing of an aircraft such as that of a civil transport airplane described in FIG. 1 generally has two categories of ailerons, low-speed outer ailerons 22, which are generally situated at the ends of the wing, and all-speed inner ailerons 23, which are generally situated nearer fuselage 24, sometimes even near engine 39. The number of ailerons per wing is determined as a function of the size of the aircraft and therefore the size of the wing.

The presence of ailerons plays a determining role for the quality of the flight and the comfort of the passengers. While assuring the stability of the airplane, they also permit reducing the aerodynamic load of the wing in the case of extreme flight conditions, which thus permits avoiding the structural overload encountered in the case of extreme flight conditions.

Thus, the principal function of the ailerons is to assure:

the stabilization and maneuverability of the aircraft by conducting an asymmetric deflection in order to create a difference of lift between the two wings, thus permitting equilibrating the airplane, or moving it around its longitudinal axis, generally also called roll axis, which goes from the front to the back of the aircraft.

a spoiler effect by carrying out a symmetrical deflection towards the top. This function is activated only when the aircraft is on the ground and aims to participate in the braking of the aircraft by increasing its drag and reducing the residual lift in order to increase the efficacy of braking,

aid in controlling yaw by conducting a deflection of the ailerons of one wing in order to increase the drag of this wing and thus generate a yawing moment,

unloading of the end of the wing in a maneuver (MLA) or in a sudden squall or gust of wind (GLA/TLA) thus permitting reducing the stress experienced by the wing, in particular the flexion moment taken up at the level of the junction between the wing and the fuselage of the aircraft. These functions of redistributing the loads are of increasing importance, since by reducing the dimensioning loads, they permit reducing the structural mass of the aircraft.

FIG. 2 schematically shows a perspective view of one example of embodiment of the aileron of the prior art. It is made up of an airfoil 34 articulated around five articulation points P1, P2, P3, P4 and P5, by means of two actuators 25, 26 designed to move surface 34 towards the top or towards the bottom. In nominal operation, there is an active actuator and a passive actuator, the passive actuator being used in the case of failure of the active actuator or in case of breakdown of the hydraulic circuit feeding the active actuator. Generally, the number of articulation points and the number of actuators is not imposed and it is a function of the size of the surface to be moved.

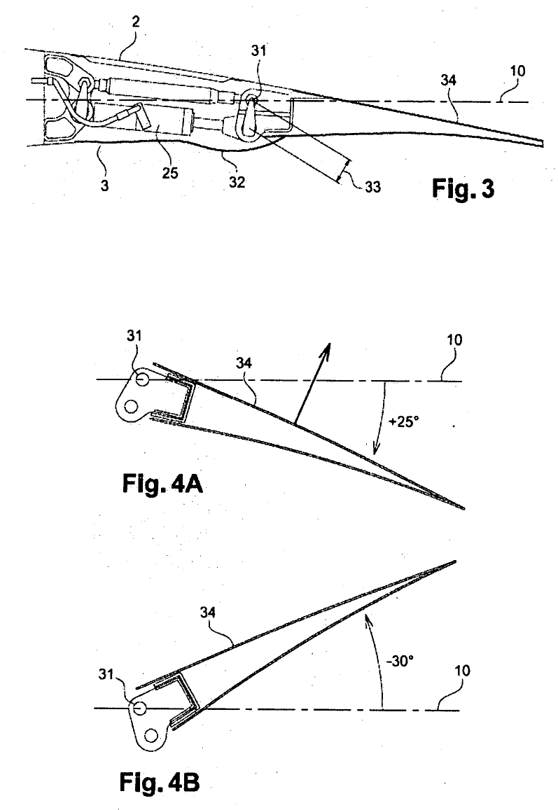

FIG. 3 shows a profile view in partial section along a cross section AA of the aileron of FIG. 2. Surface 34 is situated in the extension of the end of the trailing edge of the wing, continuous with upper surface 2 and lower surface 3 of the wing. In rest position relative to an articulation axis 31, surface 34 creates an aerodynamic continuity with the wing. In functioning position, surface 34 is inclined towards the bottom or is raised towards the top, forming an angle relative to a longitudinal axis 10 perpendicular to articulation axis 31. FIG. 3 shows that the end of actuator 25 is connected to surface 34, offset relative to articulation axis 31. A lever arm 33 generated by this offsetting, corresponding to the distance between the articulation axis of the surface and the anchoring point of the actuator measured perpendicularly to the axis of the actuator, permits driving the aileron in rotation. The other end of the actuator is attached to a structural element of the wing, which is generally the rear spar of the wing (not shown in FIG. 3).

Although other types of actuators can be used, most often the ailerons are moved by means of hydraulic actuators, i.e., using a hydraulic fluid under pressure.

Because of its shape, the wing has very little volume available at its trailing edge 30, which has a very thin profile; consequently, the mechanical assembly comprising actuator 25, 26, the hydraulic circuit that feeds the actuator, as well as lever arm 33 occupy a zone of relatively limited volume. This geometric constraint consequently limits the length of lever arm 33. Now, the aileron is a highly aerodynamically loaded surface, due to its location at the trailing edge of the wing and the functions that it must carry out. The small lever arm associated with a large aerodynamic load necessitates the use of actuators capable of generating forces from 15 to 20 tons to drive the aileron in rotation and deflect it at the angle corresponding to the function for which it is called upon. Actuators capable of generating such a level of force are generally voluminous, principally due to the piston section. Consequently, the installation of such a device is relatively complex. Likewise, the actuators require a large volume of pressurized fluids, which impacts the dimensioning of the hydraulic supply circuits and the hydraulic pressurization pumps, consequently generating a large consumption of energy and therefore an increased consumption of fuel.

Another problem generated by such an aileron device is the spatial extension of the profile of the wing necessary to receive the mechanical assembly comprising the actuators and the lever arms, due to this lack of volume in the zone of trailing edge 30. FIG. 3 shows that this spatial extension renders necessary the presence of a fairing 32 around the mechanical assembly. Notably, in order not to limit the lever arm 33 too much, since this arm must provide considerable labor, a padding or strengthening at the level of lever arm 33 is created on the side of the lower surface of the wing. The presence of fairing 32 creates a parasitic drag which consequently reduces the aerodynamic efficacy of the aircraft, leading to an increase in fuel consumption by the aircraft engines in order to overcome drag resistance.

The aileron device of the prior art therefore does not conform in an optimal way to the current requirements of the aeronautic sector, which aims at reducing fuel consumption, due, on the one hand, to its very high cost, and on the other hand, to its harmful impact on the environment.

Moreover, at null deflection angle, the ailerons are an integral part of the trailing edge of the wing; the two outer upper and lower surfaces of the aileron both play an important role from the aerodynamic point of view. They must fulfill the same aerodynamic requirements that are imposed on the upper surface of the wing. One of the requirements concerns the state of these surfaces. In fact, the flow of air that is found above the wing regularly follows the line of the upper surface. If the surface is not perfectly smooth and uniform, the air flow cannot follow the surface in a regular manner. This phenomenon can create a depression at the level of the upper surface, which reduces the lift of the wing. These aerodynamic requirements consequently involve a very specific and complex aileron manufacturing technology, and involve a high manufacturing cost.

The disclosed embodiments propose a device with mobile airfoils, simple in its design and in its operating mode, economic and robust, and assuring a good control of wing lift, while resolving the technical problems in terms of mass and complexity of installation of the assembly, all of which generates an increased fuel consumption cost in ailerons of the prior art.

For this purpose, the disclosed embodiments concern a device for mobile airfoils that can locally modify the lift of an aircraft wing.

According to the disclosed embodiments, said device comprises an upper panel and a lower panel, and at least one actuator per panel to move said panels independently from one another, between a first position called rest, in which the outer surface of each of said panels forms a continuous surface with the upper surface and the lower surface of the wing, respectively, and a second position, in which one of the two panels is deployed to form an angle with the corresponding surface of the wing, said actuators being positioned between said upper and lower panels in a recess of the wing.

According to one embodiment, said recess designed to receive said actuators is a recess enclosed by said upper and lower panels of said device.

Each panel comprises an axis of rotation at one end connecting said panel to a first structural element of the wing via a panel fastening support, and at its other end, to at least one attachment point to connect said panel to one end of said at least one actuator. The other end of said actuator is also attached via an actuator fastening support, to a second structural element of the wing.

Preferably, said actuator is positioned obliquely relative to the corresponding panel, so as to create a lever arm between the axis of rotation and the attachment point.

According to one embodiment, said first structural element and said second structural element are respectively the front spar and the rear spar of the wing.

In another embodiment, said recess designed to receive said actuators is a recess defined by the rear spar of the wing and the upper and lower surfaces of the wing, said recess being situated on the trailing edge of the wing.

Advantageously, said wing comprises an airtight box defined by the front and rear spars of the wing, and enclosed by the upper and lower surfaces of the wing, said box being contiguous with said recess situated on the trailing edge.

In this embodiment, the outer upper and lower surfaces of said airtight box each have an indentation of a dimension suitable for receiving the corresponding panel. The end of the panel is fastened to the lateral edge generated by said indentation via a panel fastening support. The actuator fastening support is fastened onto the rear spar of the side of said recess defined by the rear spar and the upper and lower surfaces of the wing.

Advantageously, said device comprises an abutment designed to hold said panels in the rest position.

Advantageously, only the outer surfaces of said upper and lower panels are designed so as to be able to create an aerodynamic continuity with the wing when the panels are not deployed.

The mobile airfoil device of the disclosed embodiments can be applied to aircraft wings, but also to any aerodynamic device requiring a mobility of the airfoils.

The disclosed embodiments will be described in more detail by reference to the attached drawings in which:

FIG. 1 is a top view of an airplane whose wings bear outer and inner ailerons according to the prior art, situated at the level of the trailing edge of the wing, at the end of the wing and to the right of the engine, respectively;

FIG. 2 is a perspective view of an example of embodiment of an aileron according to the prior art;

FIG. 3 is a sectional profile view along section AA of the aileron shown in FIG. 2;

FIGS. 4A and 4B are simplified views of FIG. 3, showing the aileron in a position of deflection towards the bottom at an angle of 25° and in a position of deflection towards the top at an angle of 30°, respectively;

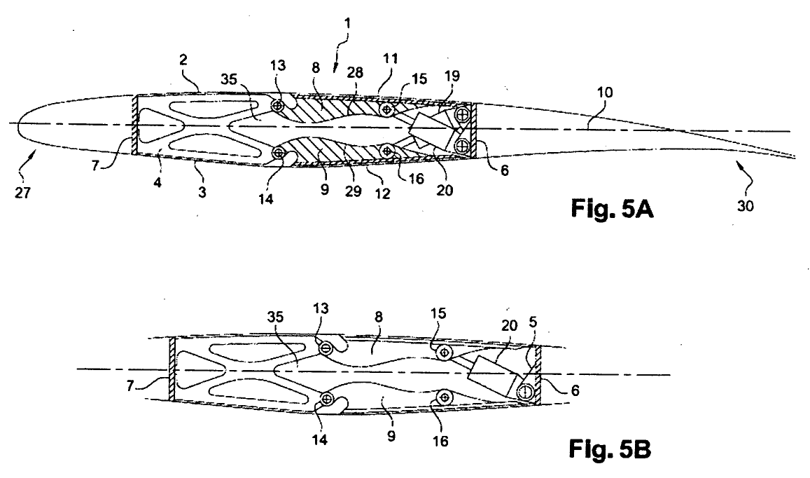

FIG. 5A is a sectional schematic view of a mobile airfoil device according to a first embodiment, having an upper panel and a lower panel, each panel being activated by means of an actuator;

FIG. 5B shows a simplified view of the device of FIG. 5A with a single actuator, demonstrating an oblique configuration of the actuator relative to the corresponding panel, so as to create a lever arm between the axis of rotation of the panel and the axis of attachment of the panel to the actuator;

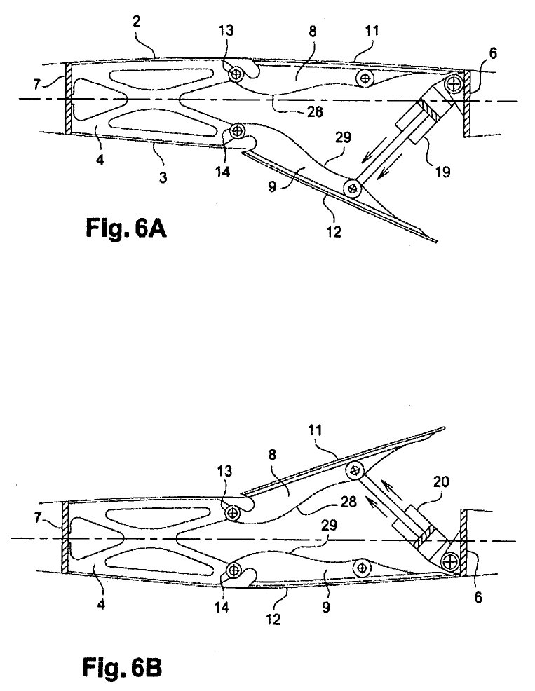

FIG. 6A and FIG. 6B represent the device of FIG. 5A in a position of deflection towards the bottom and in a position of deflection towards the top, respectively;

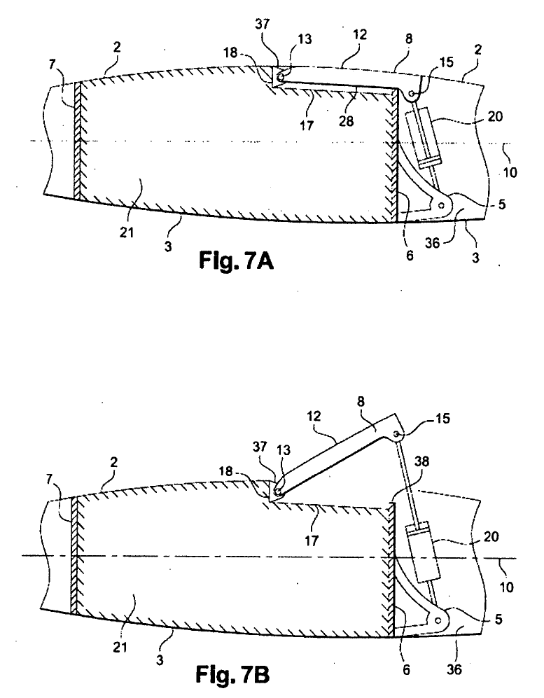

FIG. 7A and FIG. 7B schematically show a second preferred embodiment of the invention, in rest position and in position of deflection towards the top, respectively; for purposes of clarity, a single panel and a single corresponding actuator are shown in the Figures;

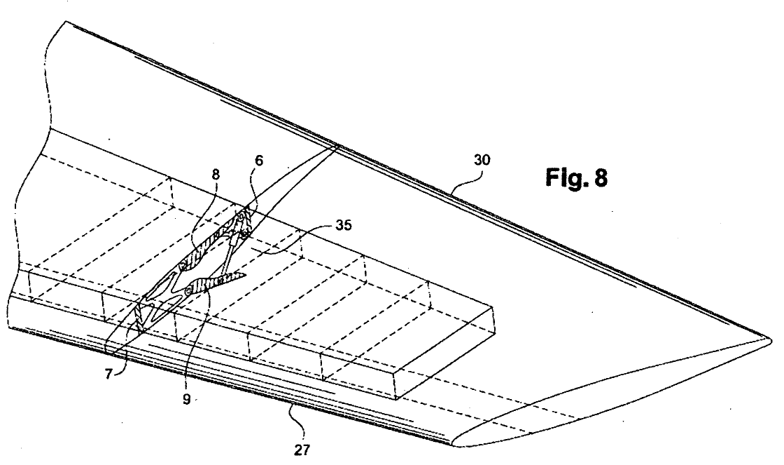

FIG. 8 schematically shows a sectional view of an aircraft wing, illustrating an example of integration of the device created according to the first embodiment in the wing.

In a known manner, the interior architecture of the wing of an aircraft illustrated in FIG. 5A, for example, is a structure of boxes that are generally delimited by a front spar 7 and a rear spar 6, and enclosed by upper surface 2 and lower surface 3 of the wing. The spars are then connected together by ribs that reinforce the wing structure. Currently, the wing boxes that are found in the median part of the wing, between leading edge 27 and trailing edge 30 of the wing, generally serve as fuel tanks, most often with the exception of those that are situated at the end of the wing, in the zone of the outer aileron.

The functional architecture of the device of the disclosed embodiments permits avoiding constraints of form and volume imposed by the very thin profile of the trailing edge of a wing that one encounters in the prior art, by integrating the device in its entirety in the structure of the wing in order to be able to benefit from recesses made by the pre-existing boxes in the wing.

FIGS. 5A and 5B illustrate a first embodiment of such a mobile airfoil device 1 integrated within the structure of the wing, comprising an upper panel 8 and a lower panel 9, both panels being roughly symmetrical relative to a longitudinal axis 10. Movements of deflection towards the top and towards the bottom of upper panel 8 and of lower panel 9 are controlled by at least one actuator 20, 19, respectively, relative to axis 10. Each panel has an axis of rotation 13, 14 at one end, around which the panel is articulated by means of the corresponding actuator, whose end is fastened at attachment point 15, 16 onto inner surface 28, 29 of the panel. When the panels are in rest position, the outer surfaces of panels 11, 12 form an aerodynamic continuity, with upper surface 2 and lower surface 3 of the wing, respectively.

The recess in which the actuators to move the panels are taken up is a recess 35 delimited by front spar 7 and rear spar 6, and enclosed by upper panel 8 and lower panel 9. In order to maintain and reinforce the structural strength of the wing, which is generally assured by the box architecture, structural reinforcements (not shown) are added around recess 35 for the present case of the invention in order to reconstitute the box architecture.

In a general way, recess 35 is a median zone of the wing situated between leading edge 27 and trailing edge 30 of the wing in a zone of relatively large volume.

An assembly of elements having at least one panel fastening support 4 and at least one actuator fastening support 5 designed to connect the panels and the actuators to a first structural element of the wing and to a second structural element of the wing, respectively, are taken up inside recess 35. In the present embodiment, the first structural element and the second structural element of the wing are front spar 7 and rear spar 6, respectively, onto which are fastened the at least one panel fastening support 4 and the at least one actuator fastening support 5, respectively.

In the example of embodiment shown in FIG. 5A, panel fastening support 4 is a one-piece block contributing to the structural reinforcement of the [spar] box. It comprises a first roughly straight lateral edge fastened to front spar 7 of the wing and a second lateral edge permitting taking up rotation axes 13, 14 of the panels. This fastening support 4 is covered by outer surfaces 2, 3 of the wing. The second lateral edge here can bear an upper projection and a lower projection, such as shown in FIG. 5A, each of these projections being designed to receive rotation axis 13, 14 of corresponding panels 8, 9. The ends of actuators 19, 20 are each fastened, for example, onto an actuator fastening support 5, or onto a single one-piece support.

FIG. 5B illustrates an optimal configuration of the device in terms of the thrust power of the actuators. In fact, each actuator is positioned obliquely relative to the corresponding panel so as to create a significant lever arm that can generate a maximum aerodynamic force, thus permitting optimally adapting the stop load of the actuator and therefore minimizing the structural mass of the aircraft in the zone concerned. In FIG. 5B, the lever arm associated with panel 8 corresponds to the distance between attachment point 15 and rotation axis 13 when it is measured perpendicularly to the axis of actuator 20.

FIGS. 6A and 6B show actuators 19 and 20, respectively, in the thrust phase. When panels 8, 9 are not deflected, unlike as shown in FIGS. 6A and 6B, actuators 19, 20 are retracted and their length is minimal. During deflection of one of the two panels in order to act on the aerodynamic behavior of the wing, the corresponding actuator exerts a thrust force on the panel which is deflected by conducting a rotation around its axis of rotation.

FIG. 6A shows the movement of actuator 19, which exerts a thrust towards the bottom on lower panel 9 by making it articulate around rotation axis 14; the panel under the effect of the thrust is deployed by forming an angle with lower surface 3 of the wing. This configuration is similar to the configuration of a classical aileron in deflection towards the bottom, which is shown in FIG. 4A.

In a similar manner, FIG. 6B shows that the movement of actuator 20 exerts a thrust towards the top on upper panel 8 by making it articulate around rotation axis 13; under the effect of this thrust, panel 8 is deployed by forming an angle with upper surface 2 of the wing. This configuration is similar to the configuration of a classical aileron in deflection towards the top, which is shown in FIG. 4B.

The angular range of rotation of the panel is preferably between 0° and 50°.

In the case considered, each panel is moved by a single actuator. But the number of actuators is not limited; it can be adapted as a function of the size of the panel to be moved.

In a general way, the actuators can be hydraulic, whose force is generated by two-way hydraulic cylinders whose functioning is well known and widely used. But electric or pneumatic actuators can also assure the same functioning, or possibly there can be a combination among all the mechanisms cited above.

In the present embodiment, the two panels 8, 9 are moved independently from one another; also, the use of two independent valves, each acting on actuators 19, 20, is necessary.

FIGS. 7A and 7B describe a second preferred embodiment in which the recess that takes up the actuators in order to move the panels is a recess 36 delimited by rear spar 6 and upper surface 2 and lower surface 3 of the wing, situated on the trailing edge of wing 30.

The assembly of fastening supports designed to connect the panels and the actuators to a structural element of the wing is situated beyond an airtight box 21 defined by front spar 7 and rear spar 6, and enclosed by upper surface 2 and lower surface 3 of the wing, the box being contiguous with recess 36 situated on the trailing edge of the wing. Advantageously, airtight box 21 is a box integrated with the wing box or a box adjacent to the wing box, able to fulfill the function of a fuel tank.

The functional architecture of the device is similar to that of the first embodiment; the device still has two roughly symmetrical panels relative to a longitudinal axis 10. For purposes of clarity, in FIGS. 7A and 7B, the device is used only with upper panel 12, in a rest position and in a position of deflection towards the top, respectively.

The outer upper wall of the airtight box comprises an indentation 17 of a suitable dimension to receive upper panel 8, one end of which is articulated onto a fastening support 37 via a rotation axis 13, the fastening support being itself fastened to a lateral edge 18 generated by the indentation. The other end of panel 12 is attached to actuator 20 via an anchoring point 15. Fastening support 5 onto which is fastened actuator 20 is fastened to rear spar 6, on the side of recess 36 situated at the end of the wing.

Advantageously, when upper panel 8 is in the rest position, its outer surface 12 creates an aerodynamic continuity with the upper surface of wing 2.

FIG. 7B illustrates the device with upper panel 8 in the position of deflection towards the top to modify the aerodynamic behavior of the wing. Actuator 20 exerts a thrust movement towards the top of upper panel 8 by making it articulate around axis 13. The panel thus forms an angle with upper surface 2 of the wing.

Advantageously, according to the embodiments described above, the inner surface 28, 29 of the edge opposite the axis of rotation of each panel 8, 9 comes to abut the wing structure during the phases of flight when the panels are not deflected. FIG. 7B illustrates one example of abutment 38 situated at the end of the wall of box 21 at the level of rear spar 6, permitting pre-stressing panel 8 on the wing. The device of the disclosed embodiments advantageously permits a relatively flexible design of the panel, and therefore a minimal mass of the panel, without harming the shape of the panel during flight phases, the shape being assured by the contact between the panel and the wing at the level of the structural abutment.

Advantageously only outer surfaces 11, 12 of the panels assure an aerodynamic function, regardless of the deflection of the panel. Inner surfaces 28, 29 of the panels do not have an aerodynamic function; a simple self-stiffening panel can also be used, which permits reducing the mass and the cost of the panel when compared with a classical aileron design.

In a general way, the panels are of composite or metal materials, or a combination of the two materials.

The mobile airfoil device of the disclosed embodiments can be used for operating an aileron without having all the technical disadvantages present in the classical aileron.

Due to the volume of recess 35, 36 where the actuator assembly for moving the panels is installed, the lever arm generated between the actuator and the axis of rotation of the panel can be very large. Consequently, it will be possible to reduce the force to be provided by the actuator to deflect the panel. This advantageously permits a perceptible reduction in the mass of the actuator and the surrounding structures.

Advantageously, the present device permits eliminating fairing 32, the cylinder and the lever arm being completely integrated in the profile of the wing. This elimination of the fairing consequently reduces parasitic drag.

The device of the disclosed embodiments therefore permits reducing fuel consumption while being a simple device in its design. It can be integrated in any type of wing having a box structure.

FIG. 8 illustrates an example of integration of the device of the invention in an aircraft wing.

Advantageously, the device of the disclosed embodiments can be controlled remotely by being connected to a control means situated at the level of the cockpit by a logic unit. This means of control permits the pilot to control the movements of panels 8, 9 in order to assure the functions generally attributed to ailerons.

The disclosed embodiments are presented within the scope of application to wing ailerons, but can also be used for any aerodynamic device requiring actuators to move at least one airfoil.

1. A mobile airfoil device (1) that can locally modify the lift of an aircraft wing, characterized in that said device comprises an upper panel (8) and a lower panel (9), and at least one actuator (19, 20) per panel in order to move said panels independently from one another between a first position, called rest, in which the outer surface (11, 12) of each of said panels (8, 9) forms a continuous surface with upper surface (2) and lower surface (3), respectively, of the wing, and a second position in which one of the two panels is deployed to form an angle with the corresponding surface of the wing, said actuators (19, 20) being positioned between said upper and lower panels (8, 9) in a recess of the wing.

2. The device according to claim 1, further characterized in that said recess designed to receive said actuators (19, 20) is a recess (35) enclosed by said upper panel (8) and lower panel (9) of said device (1).

3. The device according to claim 2, further characterized in that each panel (8, 9) comprises a rotation axis (13, 14) at one end, connecting said panel via a panel fastening support (4) to a first structural element of the wing, and at its other opposite end, at least one attachment point (15, 16) in order to connect said panel to one end of said at least one corresponding actuator (19, 20).

4. The device according to claim 3, further characterized in that the other end of said at least one actuator (19, 20) is fastened via an actuator fastening support (5) to a second structural element of the wing.

5. The device according to claim 3, further characterized in that said first structural element and said second structural element of the wing are front spar (7) and rear spar (6) of the wing, respectively.

6. The device according to claim 1, further characterized in that said recess designed to receive said actuators (19, 20) is a recess (36) delimited by rear spar (6) of the wing and upper surface (2) and lower surface (3) of the wing, said recess being situated on the trailing edge of the wing.

7. The device according to claim 6, further characterized in that said wing has at least one airtight box (21) delimited by front spar (7) and rear spar (6), enclosed by upper surface (2) and lower surface (3) of the wing, said box being contiguous with said recess (36).

8. The device according to claim 6, further characterized in that the outer upper wall and the outer lower wall of said box (21) each have an indentation (17) of dimensions suited to receive said corresponding panel (8, 9).

9. The device according to claim 6, further characterized in that one end of panel (8, 9) is fastened via a panel fastening support (37) to lateral edge (18) generated by said indentation (17).

10. The device according to claim 1, further characterized in that said at least one actuator (19, 20) is placed obliquely relative to corresponding panel (8, 9), so as to create a lever arm between rotation axis (13, 14) and attachment point (15, 16).

11. The device according to claim 1, further characterized in that said device has an abutment (38) designed to hold said panels (8, 9) in the rest position.

12. The device according to claim 1, further characterized in that said panels (8, 9) are of composite or metal materials or a combination of the two materials.

13. The device according to claim 1, further characterized in that the outer surfaces of said upper panel (8) and lower panel (9) are designed so as to be able to create an aerodynamic continuity with the wing when the panels are not deployed.

14. The device according to claim 1, further characterized in that the actuators are hydraulic, pneumatic or electrical actuators, or a combination of said actuators.

15. An aircraft having a mobile airfoil device according to claim 1.

16. The aircraft according to claim 15, further characterized in that said aircraft comprises a control means situated at the level of the cockpit, said control means being connected to mobile airfoil device (1) by a logic unit so as to be able to control the movements of said panels (8, 9).
